(19) United States
(12) Patent Application Publication
(10) Pub. No.: US 2006/0047355 A1
(43) Pub. Date: Mar. 2, 2006

(54) Method and apparatus for adjusting characteristics of multi-layer electronic components

(75) Inventors: Kazuo Kudoh, Tokyo (JP); Minoru Hirasawa, Tokyo (JP); Tomohiko Kaneyuki, Tokyo (JP); Mitsuru Miura, Tokyo (JP)

Correspondence Address: WOLFF LAW OFFICES, PLLC, 209 Providence Road, Chapel Hill, NC, 27514, US

(73) Assignee: TDK Corporation

(21) Appl. No.: 11/211,695

(22) Filed: Aug. 26, 2005

(30) Foreign Application Priority Data
Aug. 27, 2004 (JP) 2004-248238

(51) Int. Cl. G06F 19/00

(52) U.S. Cl. 700/108

(57) ABSTRACT

A method for adjusting the characteristics of multi-layer electronic components according to the present invention includes a determination process S21 for determining the characteristics of a multi-layer electronic component, a calculation process S22 for calculating the required amount of trimming on the basis of the result of determination obtained in the determination process S21, and a trimming process S23 for applying trimming to a trimming pattern provided in the multi-layer electronic component, in accordance with the amount of trimming obtained in the calculation process. The present invention enables performing the determination process S21 and the trimming process S23 in parallel for different multi-layer electronic components instead of performing trimming concurrently with real time determination of characteristics, thus enabling efficiently adjusting the characteristics of plural multi-layer electronic components on aggregate boards.

### TECHNICAL FIELD

The present invention relates to methods and apparatuses for adjusting characteristics of multi-layer electronic components and, more particularly, to characteristics adjusting methods and characteristics adjusting apparatuses which enable efficiently adjusting the characteristics of plural multi-layer electronic components on aggregate boards.

### BACKGROUND OF THE INVENTION

Some multi-layer electronic components such as voltage-controlled oscillators (VCOs) require trimming for changing inductance or capacitance to adjust characteristics after the fabrication of the aggregate boards (refer to Japanese Patent Application Laid-Open (JP-A) Nos. 11-127031, 10-93342 and 11-214925). In general, the trimming is performed by applying a laser beam to trimming patterns to cut a portion thereof concurrently with determination of the characteristics in real time. In some cases, trimming patterns are formed on the surfaces of multi-layer electronic components while in other cases trimming patterns are formed inside of multi-layer electronic components. In general, the positions of the trimming patterns are identified through image recognition in the former cases, while specification of the positions of the trimming patterns is performed by referring to recognition marks in the latter cases.

However, in any of these cases, laser trimming is performed concurrently with determining in real time the characteristics of the multi-layer electronic component being subjected to trimming. Therefore, there has been the problem of large consumption of time for separately performing such processes for all the multi-layer electronic components on aggregate boards.

Furthermore, the methods which specify the positions of trimming patterns by referring to recognition marks have had the possibility of inducing inaccurate specification of trimming positions due to pattern deviations among layers, in the case where the recognition marks and the trimming patterns are formed on different layers. In such cases, there may be possibly cases where the laser beam is not accurately applied to trimming patterns, which has induced the problem of more consumption of time for readjustments of the trimming positions.

### SUMMARY OF THE INVENTION

Therefore, it is an object of the present invention to provide methods and apparatuses for adjusting characteristics of multi-layer electronic components which enable efficiently adjusting the characteristics of plural multi-layer electronic components on aggregate boards.

A method for adjusting the characteristics of multi-layer electronic components according to the present invention includes a determination process for determining the characteristics of a multi-layer electronic component, a calculation process for calculating the required amount of trimming on the basis of the result of determination obtained in the determination process, and a trimming process for applying trimming to a trimming pattern provided in the multi-layer electronic component, in accordance with the amount of trimming obtained in the calculation process.

The present invention enables performing the determination process and the trimming process in parallel for different multi-layer electronic components instead of performing trimming concurrently with real time determination of characteristics, thus enabling efficiently adjusting the characteristics of plural multi-layer electronic components on aggregate boards. As methods for performing the determination process and the trimming process in parallel, there are a method which performs the determination process and the trimming process in parallel on a component by component basis and a method which performs these processes in parallel on an aggregate board by aggregate board basis. In any of these cases, the trimming process can be successively performed for plural multi-layer electronic components after performing the determining process successively for the plural multi-layer electronic components, thus enabling efficiently advancing the characteristics adjusting operation for the plural multi-layer electronic components.

Accordingly, the present invention enables efficiently performing adjustments of the characteristics of multi-layer electronic components which require trimming, as typified by voltage-controlled oscillators. The trimming pattern may be a pattern which enables varying the inductance or the capacitance of itself by trimming.

In the present invention, preferably, in the trimming process, the specification of the trimming position is performed by using recognition marks indicating the relative positional relationship with respect to the trimming pattern and, preferably, the recognition marks and the trimming pattern are formed on the same plane surface. In this case, since the recognition marks have a substantially fixed relative positional relationship with the trimming pattern, it is possible to expect the required amount of trimming for providing desired characteristics with respect to the recognition marks as a reference, by determining the characteristics of the multi-layer electronic component before trimming. This can eliminate the necessity of performing trimming concurrently with determination of the characteristics, thus enabling provision of desired characteristics by performing the amount of trimming determined as a calculated value.

Preferably, the trimming pattern and the recognition marks are both formed on a predetermined insulation layer out of the plural insulation layers constituting the multi-layer electronic component and the predetermined insulation layer is an internal insulation layer which is covered at its both sides with other insulation layers. This can prevent the trimming pattern from occupying the component mounting surface of the multi-layer electronic component, thus enabling reduction of a two-dimensional size of the multi-layer electronic component.

Out of the plurality of insulation layers, the insulation layers covering the recognition marks are preferably exposed at least at the regions lying over the recognition marks. This enables visually recognizing the recognition marks with high clarity, through the insulation layers.

Preferably, in the trimming process, the trimming is performed by applying a laser beam from the side of the insulation layers covering the recognition marks with respect to the predetermined insulation layer.

Preferably, the recognition marks are arranged in the cutting allowance regions for enabling extraction of the plurality of multi-layer electronic components by cutting. In this case, the recognition marks will not occupy the effective areas at all, thus enabling reduction of the two-dimensional sizes of the multi-layer electronic components.

A characteristics adjusting apparatus for multi-layer electronic components according to the present invention includes a determining unit for determining the characteristics of a multi-layer electronic component, a calculating unit for calculating the required amount of trimming on the basis of the result of determination obtained by the determining unit, and a trimming unit for applying trimming to a trimming pattern provided in the multi-layer electronic component, in accordance with the amount of trimming obtained by the calculating unit.

Preferably, the calculating unit calculates the required amount of trimming by referring to a calculation table defining the relationship between the amount of trimming and the difference between desired characteristics and the characteristics of the multi-layer electronic component. This eliminates the necessity of performing trimming concurrently with real-time determination of the characteristics, thus enabling provision of desired characteristics by performing the amount of trimming determined as a calculated value.

The determining unit and the trimming unit are configured such that the determination by the determining unit and the trimming by the trimming unit are performed in parallel for different multi-layer electronic components.

As described above, the present invention enables performing the determination process and the trimming process in parallel for different multi-layer electronic components, thus enabling efficiently adjusting the characteristics of plural multi-layer electronic components on aggregate boards.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a schematic perspective view illustrating the construction of a multi-layer electronic components aggregate board 10;

FIG. 2 is a schematic cross sectional view schematically illustrating the construction of the multi-layer electronic component 100;

FIG. 3 is a schematic plan view illustrating the region 10a illustrated in FIG. 1 from the mounting surface 100a side in an enlarged manner;

FIG. 4 is a schematic plan view illustrating the main pattern shapes in the conductor layer 122 in an enlarged manner;

FIG. 5 is a flow chart illustrating a fabricating method of the multi-layer electronic component 100;

FIG. 6 is a view illustrating a method for specifying the position to be subjected to trimming;

FIG. 7 is a schematic view illustrating a first characteristics adjusting method, wherein there is illustrated the arrangement of multi-layer electronic components on an aggregate board;

FIG. 8 is a schematic view illustrating a second characteristics adjusting method, wherein there are illustrated plural aggregate boards;

FIG. 9 is a block diagram schematically illustrating the structure of an apparatus capable of performing the first and second characteristics adjusting methods;

FIGS. 10A to 10D are schematic plan views illustrating various pattern shapes usable as the recognition marks 122a, FIG. 10A illustrating an L-shaped pattern, FIG. 10B illustrating a round-shaped pattern, FIG. 10C illustrating a rectangular-shaped pattern and FIG. 10D illustrating a pattern having a rectangular outside shape with a hollow cross shape inside thereof; and

FIG. 11 is a view illustrating an example of trimming by applying a laser beam L from the component mounting surface 100b side.

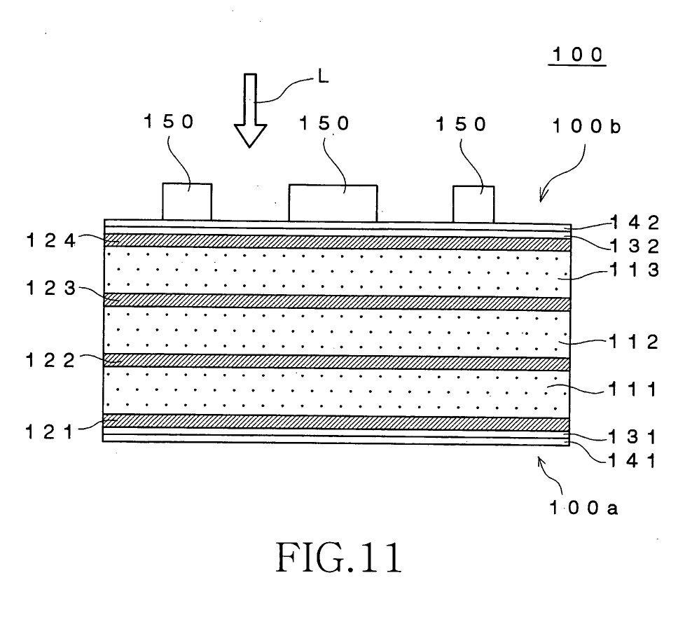

### DETAILED DESCRIPTION OF THE EMBODIMENTS

Preferred embodiments of the present invention will now be explained in detail with reference to the drawings.

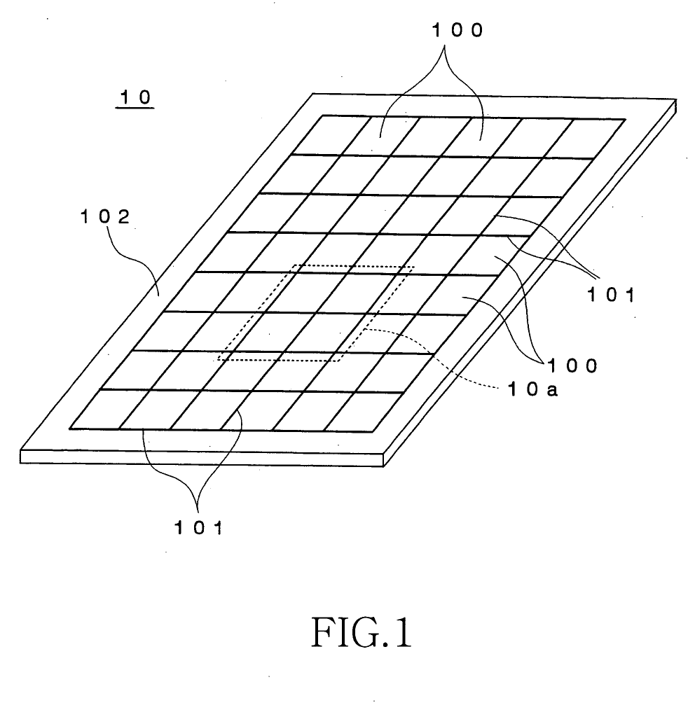

FIG. 1 is a schematic perspective view illustrating the construction of a multi-layer electronic components aggregate board 10.

As illustrated in FIG. 1, a multi-layer electronic component aggregate board 10 according to the present embodiment is constituted by a plurality of multi-layer electronic components 100 which are arranged in a matrix shape, cutting allowance regions 101 existing around the respective multi-layer electronic components 100, and a frame body 102 surrounding the multi-layer electronic components 100 which are arranged in a matrix shape. The aggregate board 10 illustrated in FIG. 1 is fabricated by an aggregate board fabricating process which will be described later and then the aggregate board 10 is cut along the cutting allowance regions 101 to enable extracting the respective multi-layer electronic components 100. The respective multi-layer electronic components 100 are multi-layer electronic components which require trimming for adjusting inductance and capacitance and are preferably voltage controlled oscillators (VCOs), but are not particularly limited thereto.

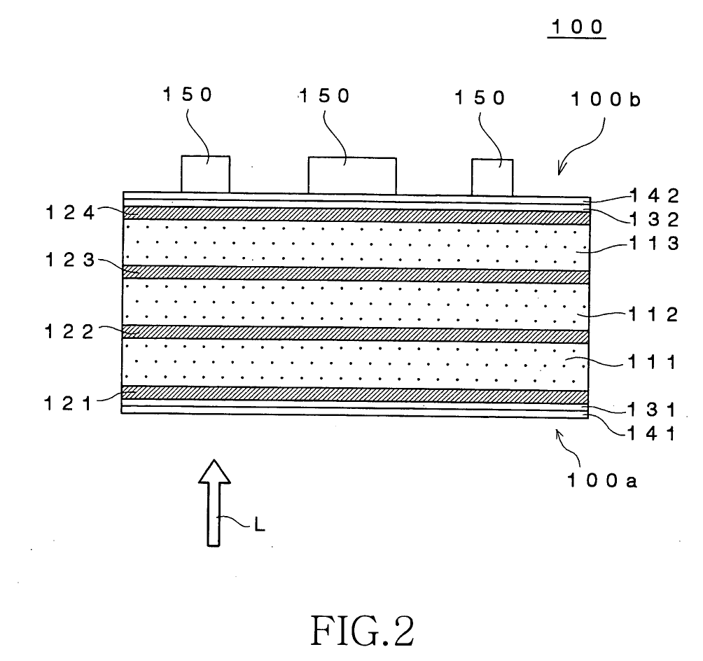

FIG. 2 is a schematic cross sectional view schematically illustrating the construction of the multi-layer electronic component 100.

As illustrated in FIG. 2, a multi-layer electronic component 100 is constituted by a plurality of insulation layers 111 to 113, conductor layers 121 to 124 provided on the surfaces of the respective insulation layers, a plated layer 131 and a resist layer 141 covering the lowermost conductor layer 121 which forms a mounting surface 100a to be placed onto a printed circuit board (not shown), a plated layer 132 and a resist layer 142 covering the uppermost conductor layer 124 which forms a component mounting surface 100b, and chip components 150 such as capacitors and transistors mounted on the component mounting surface 100b. The materials of the insulation layers 111 to 113 may be insulating resins such as epoxy resins and phenol resins and, preferably, the thickness thereof are set to within the range of about 30 micrometers to 200 micrometers, although they are not particularly limited thereto. While the present embodiment employs materials having high transparencies as the materials of all the insulation layers 111 to 113, it is preferable to employ a material with the highest possible transparency as at least the insulation layer 111.

Further, metal materials such as copper (Cu) may be employed as the materials of the conductor layers 121 to 124 and thickness are preferably set to within the range of about 10 micrometers to 20 micrometers. Further, the lowermost conductor layer 121 forming the mounting surface 100a is a ground pattern and generally covers the most portion of the insulation layer 111, although it is not particularly limited thereto.

A trimming pattern is formed in the conductor layer 122 and a laser beam L will be applied thereto from the mounting surface 100a side for trimming, which will be described in more detail later. Namely, with the present embodiment, the trimming pattern is not provided on the component mounting surface 100b (conductor layer 124), and an internal pattern on the internal insulation layer 112 which is covered at its both sides with the other insulation layers 111 and 113 constitutes the trimming pattern. Although in general multi-layer electronic components of this type include trimming patterns provided on component mounting surface (refer to Japanese Patent Application Laid-Open (JP-A) Nos. 11-127031 and 10-93342), if a trimming pattern is provided on the component mounting surface 100b, this will increase a two-dimensional size of the multi-layer electronic component, since various types of chip components are mounted on the component mounting surface 100b as previously described. In view of this point, the multi-layer electronic components 100 according to the present embodiment include trimming patterns provided in internal conductor layers 122.

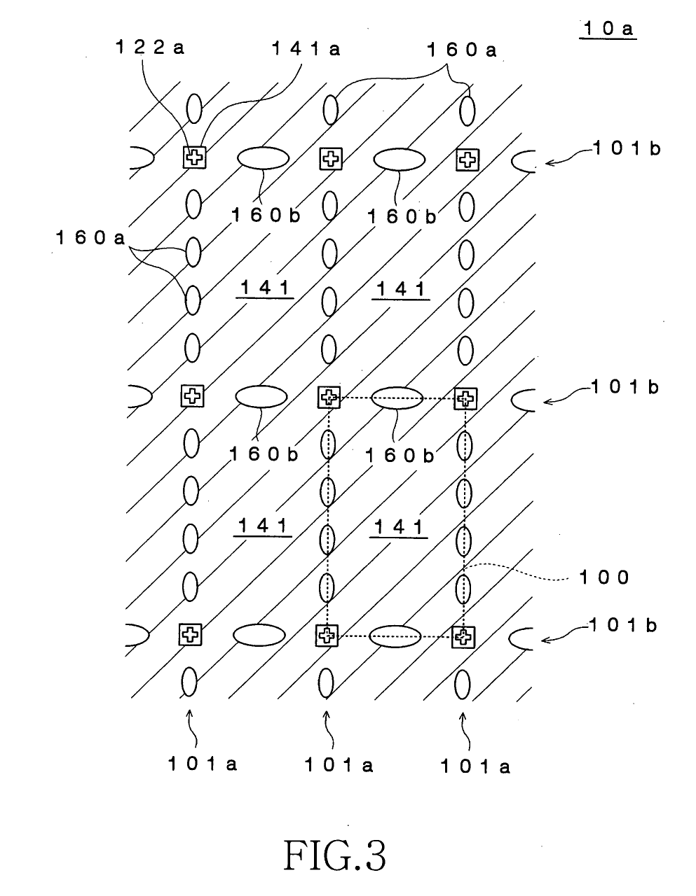

FIG. 3 is a schematic plan view illustrating the region 10a illustrated in FIG. 1 from the mounting surface 100a side in an enlarged manner.

As illustrated in FIG. 3, the aggregate board 10 according to the present embodiment is provided with a plurality of through holes 160a extending in a single direction and a plurality of through holes 160b extending in the direction orthogonal to the direction of the through holes 160a. Conductors which are not illustrated are formed on the inner walls of these through holes 160a and 160b. The regions along the through holes 160a and 160b are cutting allowance regions 101a and 101b and, by cutting the aggregate board 10 along the cutting allowance regions 101a and 101b, portions of the conductors formed on the inner walls of the through holes 160a and 160b are exposed to the surfaces to form external electrodes. In FIG. 3, a region which forms a single multi-layer electronic component 100 after cutting is indicated by a broken line.

While most portions of the mounting surfaces 100a of the respective multi-layer electronic components 100 are covered with the resist layer 141 as illustrated in FIG. 3, the regions at the intersections of the cutting allowance regions 101a and the cutting allowance regions 101b are not covered with the resist layer 141 and also not covered with the conductor layer 121 and the plated layer 131 illustrated in FIG. 2, and therefore the insulation layer 111 is exposed thereat. Since the insulation layer 111 has transparency to light, it is possible to visually recognize the conductor layer 122 through the insulation layer 111. The portions of the conductor layer 122 which correspond to the regions 141a are provided with cross-shaped recognition marks 122a and, as illustrated in FIG. 3, the cross-shaped recognition marks 122a can be visually recognized through the regions 141a. These recognition marks 122a indicate the relative positional relationship with respect to the trimming patterns formed in the same conductor layer 122 and therefore are used for specifying the positions of the trimming patterns.

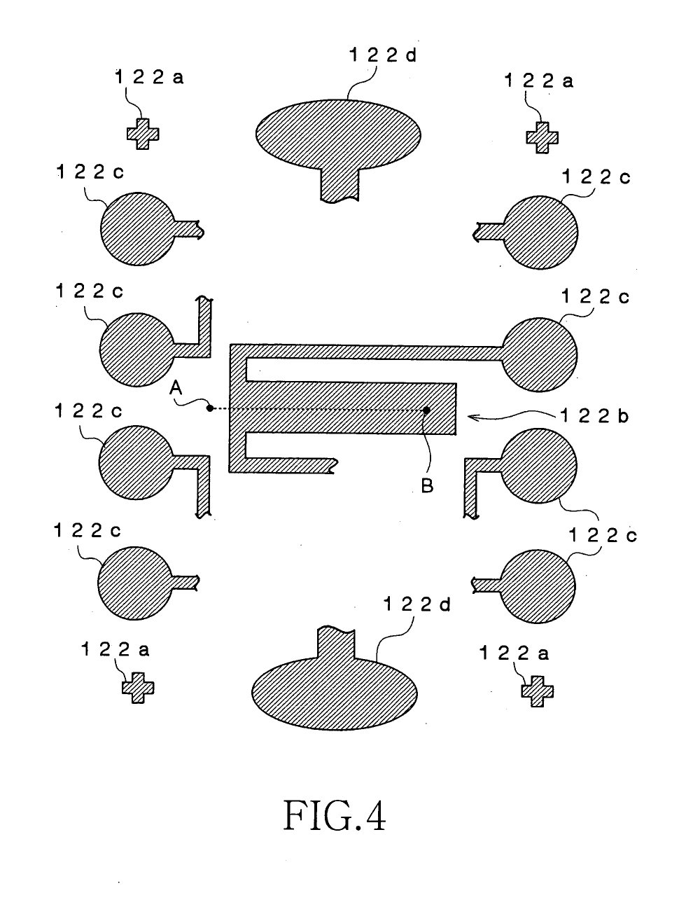

FIG. 4 is a schematic plan view illustrating the main pattern shapes in the conductor layer 122 in an enlarged manner.

As illustrated in FIG. 4, the conductor layer 122 includes the recognition marks 122a and the trimming patterns 122b and, further, electrode patterns 122c and 122d are provided respectively at the regions over which the through holes 160a and 160b are to be formed. As described above, the recognition marks 122a and the trimming patterns 122b are constituted by the same conductor layer (122) and, therefore, the recognition marks 122a and the trimming pattern 122b may be concurrently formed with a single process. Although the method for forming the conductor layer 122 is not particularly limited, a subtractive process, an additive process, a semi-additive process, a screen printing process, etc., may be employed and the utilization of any of these processes enables forming them concurrently, thus substantially preventing the occurrence of deviations in the relative positional relationship therebetween.

In the present embodiment, the trimming pattern 122b constitutes a pattern which enables adjusting the inductance of itself by trimming and, by cutting the trimming pattern 122b by a certain length from a point A to a point B illustrated in FIG. 4, the wiring length can be changed, thus changing the inductance.

Hereinbefore, there has been described the structure of the multi-layer electrode components aggregate board 10 which have been subjected to the characteristics adjustments according to the present embodiment. Next, there will be described a method for fabricating multi-layer electronic components.

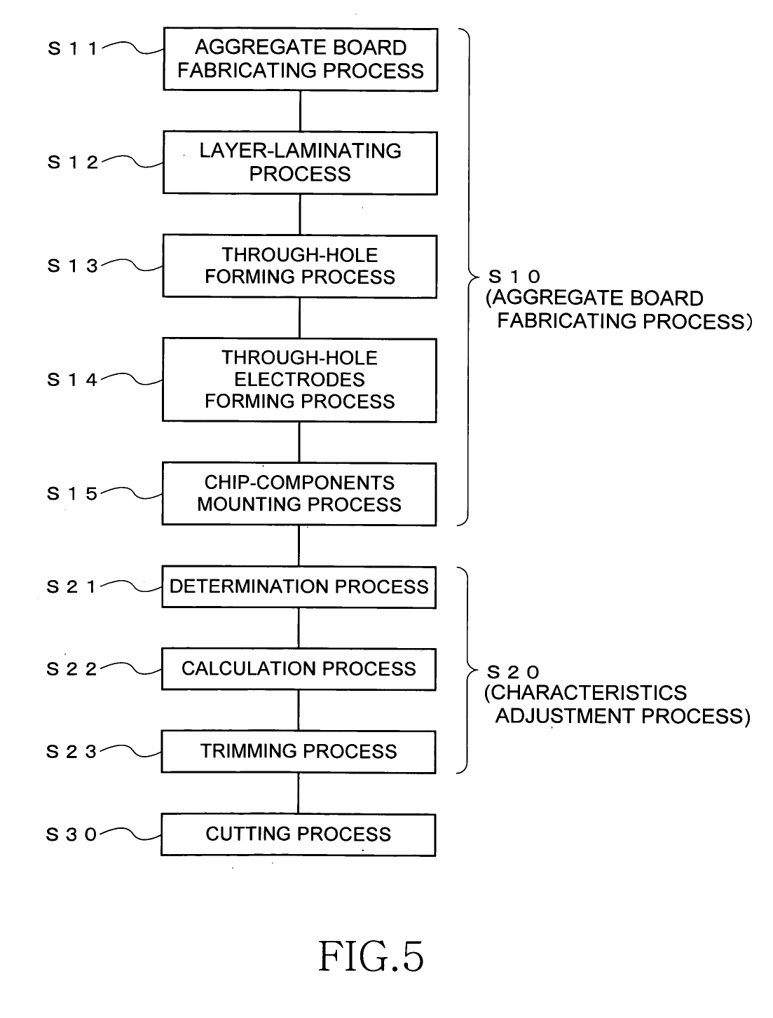

FIG. 5 is a flow chart illustrating a fabricating method of the multi-layer electronic component 100.

At first, a multi-layer electronic component aggregate board 10 as mentioned above is fabricated with an aggregate board fabricating process (step S10). The aggregate board fabricating process includes a layer-laminating process (step S11) for forming and laminating conductor layers 121 to 124 on the surfaces of the insulation layers 111 to 113, a plating and resist-forming process (step S12) for forming the plated layer 131 and the resist layer 141 covering the lowermost conductor layer 121 and for forming the plated layer 132 and the resist layer 142 covering the uppermost conductor layer 124, a through-hole forming process (step S13) for forming the through holes 160a and 160b, a through-hole electrodes forming process (step S14) for forming the conductors on the inner walls of the through holes 160a and 160b, and a chip-components mounting process (step S15) for mounting the chip components 150 on the component mounting surface 100b.

It is preferable that the layer-laminating process (step S11) includes a process for forming the conductor layers 122 and 123 on the surfaces of the insulation layer 112 which forms a core board, subsequently sandwiching them between prepregs made of uncured resin or semi-cured resin and then curing the prepregs through hot pressing to form the insulation layers 111 and 113, although the layer-laminating process is not limited thereto. In this case, the layer-laminating process includes a process for forming the patterns illustrated in FIG. 4 on the surface of the insulation layer 112 serving as the core board and, since the recognition marks 122a and the trimming patterns 122b can be concurrently formed with a single process as previously described, there will be hardly induced deviations in the relative positional relationship therebetween.

As previously described, the conductor layer 121 formed on the surface of the insulation layer 111 is generally a ground pattern. Therefore, the conductor layer 121 is formed to cover the most portion of the insulation layer 111. Thus, the conductor layer 121 covers a portion or all of the regions lying over the trimming patterns 122b. In this case, although a portion or all of the trimming patterns 122b can not be visually recognized from the mounting surface 100a side, the conductor layer 121 is formed not to cover at least the regions lying over the recognition marks 122a, which enables visually recognizing the recognition marks 122a from the mounting surface 100a side. In the plating and resist-forming process (step S12), the resist layer 141 is formed such that the regions of the surface of the insulation layer 111 which lie over the recognition marks 122a are exposed.

When the fabrication of the multi-layer electronic component aggregate board 10 has been completed as described above, then adjustments of characteristics of the respective multi-layer electronic components 100 are performed in the characteristics adjustment process (step S20). The characteristics adjustment process includes a determination process (step S21) for determining the characteristics of a multi-layer electronic component 100, a calculation process (step S22) for calculating the required amount of trimming on the basis of the result of determination obtained in the determination process, and a trimming process (step S23) for applying trimming to a trimming pattern 122b in accordance with the amount of trimming obtained in the calculation process.

First, in the determination process (step S21), characteristics of the multi-layer electronic component 100 (for example, the relationship between the controlling voltage and the oscillation frequency, in the case where the multi-layer electronic component 100 is a VCO) are determined under a condition where probes are in contact with the conductors within the through holes 160a and 160b illustrated in FIG. 3 and the multi-layer electronic component 100 is actually operated. Then, in the calculation process (step S22), the required amount of trimming is calculated from the result of determination obtained from the determination process by referring to a calculation table defining the relationship between the amount of trimming and the difference between the characteristics of the multi-layer electronic component and desired characteristics. By determining in advance the relationship between the amount of trimming and the amount of characteristics change and then defining the relationship as a mathematical expression or a table, it is possible to easily calculate the required degree of trimming only by determining the characteristics of the multi-layer electronic component 100 before trimming.

In the trimming process (step S23), as illustrated in FIG. 2, a laser beam L is applied from the mounting surface 100a side for performing trimming. The trimming is performed by cutting the trimming pattern 122b by applying the laser beam and, since the conductor layer 122 is a layer inside of the board as previously described, there exist the other conductor layer 111, the plated layer 131 and the resist layer 141 along the direction of the irradiation of the laser beam. Therefore, the trimming pattern 122b can not be directly recognized through visual recognition or image recognition. However, the conductor layer 122 includes the recognition marks 122a indicating the relative positional relationship with respect to the trimming pattern 122b and they can be recognized from the mounting surface 100a side, thus enabling specifying the trimming position by using the recognition marks 122a as a reference.

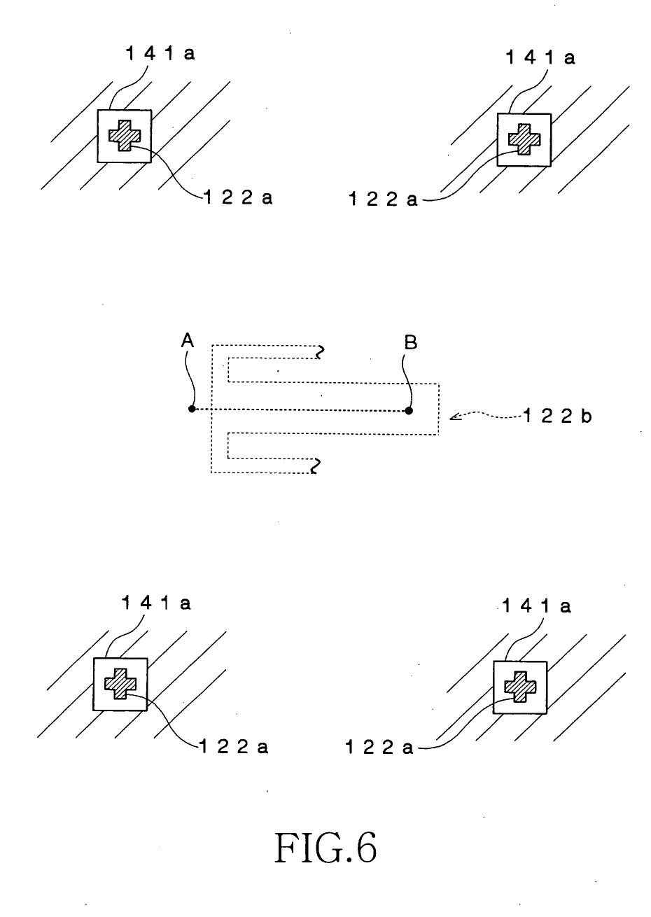

Namely, by grasping in advance the relative positional relationship between the recognition marks 122a and the trimming pattern 122b, it is possible to specify the position to be subjected to trimming by referring to the recognition marks 122a which are visible through the regions 141a by visual recognition or image recognition, although actually the trimming pattern 122b can not be viewed from the mounting surface 100a side as illustrated in FIG. 6 (there is illustrated, in FIG. 6, the unviewable pattern by a broken line). Conventionally, it has been impossible to accurately determine the positions of trimming patterns and therefore it has been necessary to perform trimming concurrently with determining the characteristics of multi-layer electronic components, since the characteristic changes of multi-layer electronic components with respect to the amount of trimming are not constant. However, with the present invention, the position of the trimming pattern 122b can be identified with high accuracy by referring to recognizing marks 122a, which enables separately performing the determination process (step S21) for the characteristics of multi-layer electronic component and the calculation process (step S22) and the trimming process (step S23). As methods thereof, there are a first method which performs the determination process, the calculation process and the trimming process in parallel on a component by component basis and a second method which performs these processes in parallel on an aggregate board by aggregate board basis.

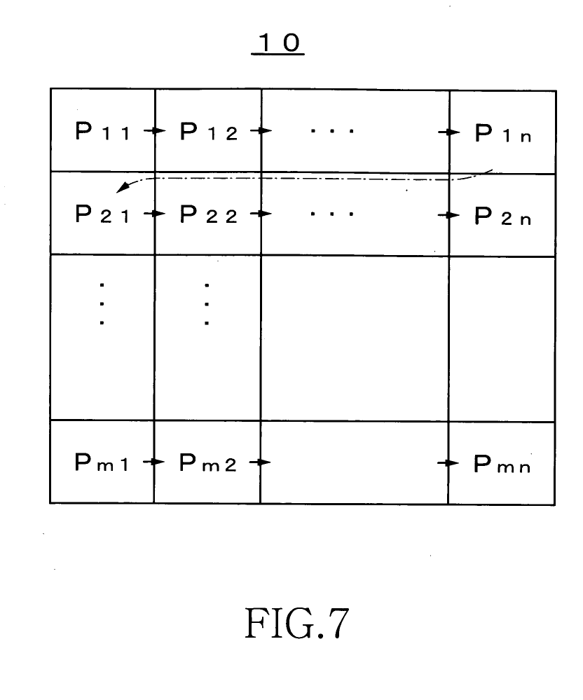

FIG. 7 is a schematic view illustrating a first characteristics adjusting method, wherein there is illustrated the arrangement of multi-layer electronic components on an aggregate board.

In the first characteristics adjusting method, the characteristics of a multi-layer electronic component P11 on an aggregate board are determined at first, as illustrated in FIG. 7. In the determination process, the characteristics of the multi-layer electronic component are determined, under a condition where the probes are in contact with the conductors within the through holes and the multi-layer electronic component is actually operated, as previously described. Then, when the determination for the multi-layer electronic component P11 has been completed, the determination process is performed for a multi-layer electronic component P12 adjacent thereto. Thus, this determination process is successively performed for the respective multi-layer electronic components on the aggregate board to complete the determination of the characteristics of all the multi-layer electronic components.

On the other hand, in parallel with the determination process for the multi-layer electronic component P12, the trimming process is performed for the multi-layer electronic component P11 for which the determination has been completed. In the trimming process, as illustrated in FIG. 6, irradiation of a laser beam L is started at a point A, the irradiated position is gradually displaced and the irradiation of the laser beam is terminated at a point B where desired characteristics have been obtained. At this time, the amount of trimming (the distance between the point A and the point B) is determined by referring to the table defining the relationship between the amount of trimming and the amount of characteristic change, in the calculation process preceding the trimming process. Then, this trimming process is successively performed for all the multi-layer electronic components on the aggregate board, in parallel with the determination process, to complete the trimming for the respective multi-layer electronic components.

As described above, in the first characteristics adjusting method, the trimming processes is performed for multi-layer electronic components for which the determination has been completed, in parallel with the determination process for other multi-layer electronic components, on a component by component basis, which enables efficiently advancing the characteristics adjusting operation for the plural multi-layer electronic components.

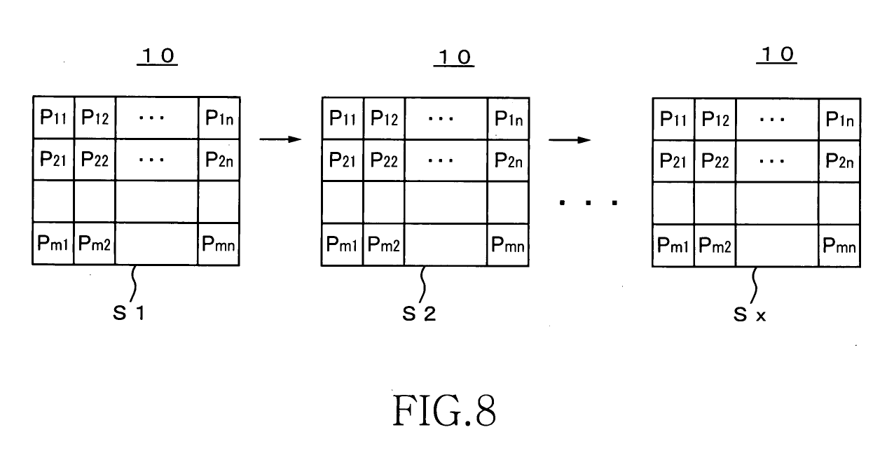

FIG. 8 is a schematic view illustrating a second characteristics adjusting method, wherein there are illustrated plural aggregate boards.

In the second characteristic adjusting method, the determination of characteristics is successively performed for the multi-layer electronic components P11 to Pmn on an aggregate board S1 at first, as illustrated in FIG. 8. Then, when the determination for the multi-layer electronic component P11 has been completed, the determination process is performed for the multi-layer electronic components on another aggregate board S2. Thus, this determination process is successively performed for the multi-layer electronic components on plural aggregate boards S1 to Sx to complete the determination of the characteristics of all the multi-layer electronic components on these aggregate boards.

On the other hand, in parallel with the determination process for the multi-layer electronic components on the aggregate board S2, the trimming process is performed for the multi-layer electronic components P11 to Pmn on the aggregate board S1 for which the determination has been completed. Thus, this trimming process is successively performed for the plural aggregate boards S1 to Sx, in parallel with the determination process, to complete the trimming for all the multi-layer electronic components on the aggregate boards.

As described above, in the second characteristics adjusting method, similarly, the trimming process is performed for multi-layer electronic components for which the determination has been completed, in parallel with the determination process for other multi-layer electronic components, on an aggregate board by aggregate board basis, which enables efficiently advancing the characteristics adjusting operation for the plural multi-layer electronic components.

Subsequently, after performing the characteristics adjusting process for the individual multi-layer electronic components 100, the aggregate board 10 is cut along cutting allowances 101a and 101b in the cutting process (step S30) to enable extracting the multi-layer electronic components 100 which have been subjected to the characteristics adjustments.

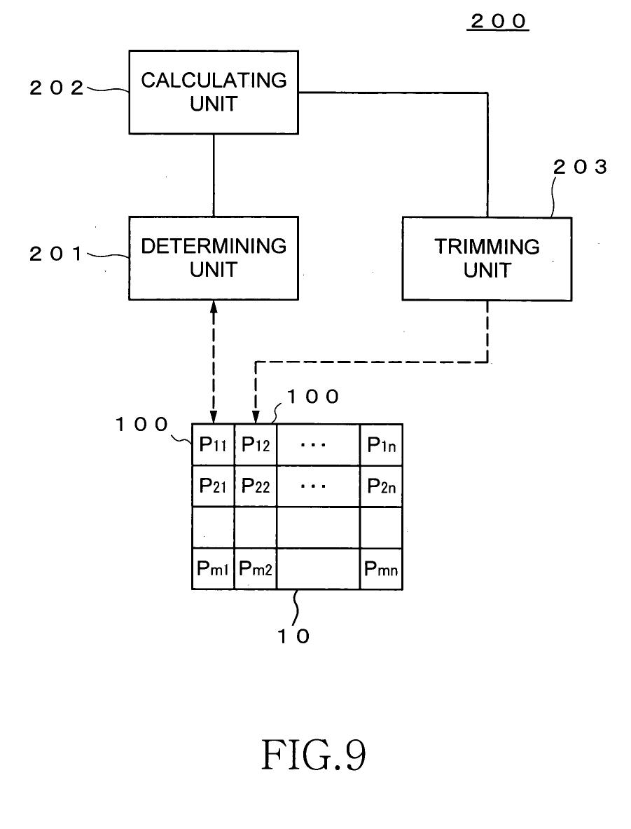

FIG. 9 is a block diagram schematically illustrating the structure of an apparatus capable of performing the first and second characteristics adjusting methods.

As illustrated in FIG. 9, this characteristics adjusting apparatus 200 is configured to include a determining unit 201 for determining the characteristics of a multi-layer electronic component, a calculating unit 202 for calculating the required amount of trimming on the basis of the result of determination obtained by the determining unit 201, and a trimming unit 203 for applying trimming to a trimming pattern provided in the multi-layer electronic component.

The determining unit 201 includes probes and determination circuits, etc., and determines the characteristics of a multi-layer electronic component. The calculating unit 202 includes a calculation table defining the relationship between the amount of trimming and the difference between desired characteristics and the characteristics of the multi-layer electronic component and calculates the required amount of trimming from the result of determination obtained at the determining unit 201, by referring to the calculation table. The trimming unit 203 includes a laser device and an image processing apparatus for distinguishing recognition marks, etc., and applies trimming to the trimming pattern provided in the multi-layer electronic component, in accordance with the amount of trimming obtained by the calculating unit 202.

Here, the determining unit 201 and the trimming unit 203 are configured independently of each other such that the determination by the determining unit 201 and the trimming by the trimming unit 203 are performed in parallel for different multi-layer electronic components. For example, in the case of performing the first characteristics adjusting method, the determining unit 201 and the trimming unit 203 are configured to perform the determination process for a multi-layer electronic component on an aggregate board while performing the trimming process for another multi-layer electronic component on the same aggregate board. Further, in the case of performing the second characteristics adjusting method, the determining unit 201 is configured to perform the determination process for the multi-layer electronic components on an aggregate board while the trimming unit 203 is configured to perform the trimming process for the multi-layer electronic components on another aggregate board. This configuration enables performing the trimming process in parallel with the determination process for other multi-layer electronic components, thus enabling efficiently advancing the characteristics adjusting operation for plural multi-layer electronic components.

As previously described, the present embodiment performs the trimming process for multi-layer electronic components for which the determination has been already completed, in parallel with the determination process for other multi-layer electronic components, thus enabling efficiently advancing the characteristics adjusting operation for plural multi-layer electronic components.

Further, with the present embodiment, since there are provided, in the aggregate board 10, the recognition marks 122a indicating the relative positional relationship with respect to the trimming patterns 122b, it is possible to specify the trimming positions with significantly simple processes even in the case of specifying the trimming positions through image recognition. Furthermore, since the recognition marks 122a are conductor layers formed on the layer on which the trimming patterns 122b are formed, they can be concurrently formed with a single process. This can prevent the occurrence of pattern deviations therebetween in principle, thus enabling specifying the trimming positions with extremely high accuracy.

Further, with the present embodiment, since the trimming patterns 122b are provided in the internal conductor layer 122, the trimming patterns do not occupy the component mounting surfaces 100b, thus enabling reduction of two-dimensional sizes of the multi-layer electronic components 100. Furthermore, with the present embodiment, since the recognition marks 122a are arranged along the cutting allowance regions 101a and 101b, the recognition marks 122a do not occupy the effective areas on the aggregate board at all.

Further, if trimming patterns are formed on the mounting surface 100a, the conductor constituting the trimming patterns will be dispersed therearound during trimming thus inducing short-circuit malfunctions. However, with the present embodiment, the trimming patterns 122b are provided in the internal conductor layer 122, thus preventing the occurrence of such a problem.

Further, by providing the trimming patterns 122b in the internal conductor layer 122 as in the present embodiment, the trimming patterns 122b are covered at its both sides with the insulation layer 111 and the insulation layer 112 thus providing more stable electrical characteristics than the case of forming the trimming patterns on the mounting surface 100a.

As described above, the present embodiment enables easily specifying the trimming position with high accuracy and also enables miniaturizing the completed multi-layer electronic components 100.

The present invention is in no way limited to the aforementioned embodiments, but rather various modifications are possible within the scope of the invention as recited in the claims, and naturally these modifications are included within the scope of the invention.

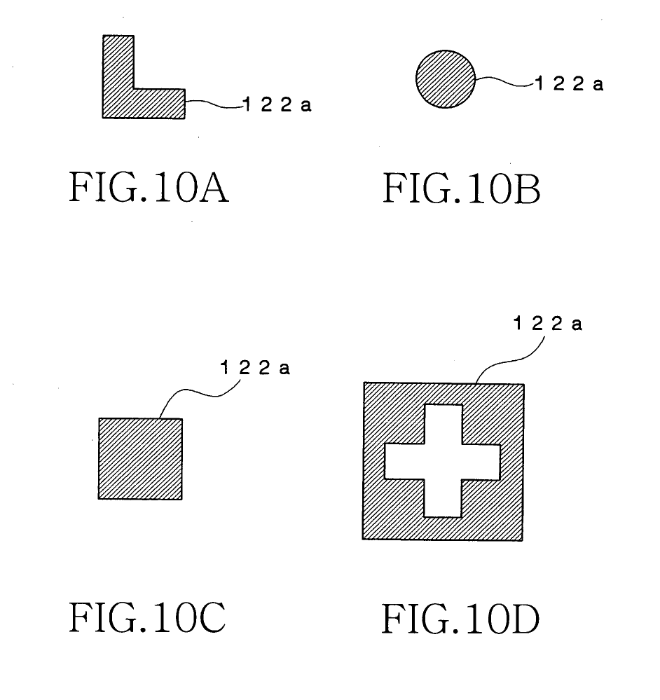

For example, while the embodiment employs cross-shaped patterns as the recognition marks 122a, the recognition marks 122a are not limited thereto and may be any patterns indicative of the relative positional relationship with respect to the trimming patterns 122b. Therefore, they may be L-shaped patterns as illustrated in FIG. 10A, round-shaped patterns as illustrated in FIG. 10B, rectangular-shaped patterns as illustrated in FIG. 10C or patterns having a rectangular outside shape with a hollow cross shape inside thereof as illustrated in FIG. 10D.

Further, while the embodiment performs trimming by applying a laser beam L from the mounting surface 100a side, the trimming may be performed by applying a laser beam L from the component mounting surface 100b side as illustrated in FIG. 12. In order to embed a trimming pattern in the example of FIG. 12, the trimming pattern and recognition marks may be provided in the second conductor layer 123 from the component mounting surface 100b. Further, it is not necessary that the direction of visual recognition of the recognition marks is coincident with the direction of irradiation of the laser beam L and, for example, the recognition marks may be visually recognized from the mounting surface 100a side while the laser beam may be applied from the component mounting surface 100b side.

Further, while the embodiment employs variable-inductance patterns as the trimming patterns 122b, the trimming patterns 122b may be any patterns which enable adjusting the characteristics of the multi-layer electronic components and may be, for example, variable-capacitance patterns.

Further, while in the embodiment the regions 141a are not covered with the conductor layer 121, the plated layer 131 and the resist layer 141 so that the insulation layer 111 is exposed thereat, it is not necessary that the insulation layer 111 is exposed at the regions 141a and the regions 141a may be covered with some layers as long as the recognition marks 122a can be visually recognized.

Further, while the embodiment employs the recognition marks 122a placed at the intersections of the cutting allowance regions 101a and 101b, the positions of the recognition marks are not particularly limited as long as they are formed on the plane surface on which the trimming patterns are formed. However, by placing the recognition marks along at least one of the cutting allowance regions 101a and the cutting allowance regions 101b, it is possible to prevent the recognition marks from occupying the effective areas.

What is claimed is:

1. A method for adjusting a characteristics of a multi-layer electronic component, comprising:
a determination process for determining the characteristics of the multi-layer electronic component;
a calculation process for calculating a required amount of trimming on a basis of a result of determination obtained in the determination process; and
a trimming process for applying trimming to a trimming pattern provided in the multi-layer electronic component in accordance with the amount of trimming obtained in the calculation process.

2. The method for adjusting a characteristics of a multi-layer electronic component as claimed in claim 1, wherein a specification of the trimming position in the trimming process is performed by using recognition marks indicating a relative positional relationship with respect to the trimming pattern.

3. The method for adjusting a characteristics of a multi-layer electronic component as claimed in claim 2, wherein said recognition marks and said trimming pattern are formed on the same plane surface.

4. The method for adjusting a characteristics of a multi-layer electronic component as claimed in claim 3, wherein said trimming pattern and said recognition marks are both formed on a predetermined insulation layer out of a plurality of insulation layers constituting the multi-layer electronic component, and the predetermined insulation layer being an internal insulation layer which is covered at its both sides with other insulation layers.

5. The method for adjusting a characteristics of a multi-layer electronic component as claimed in claim 4, wherein a insulation layer out of the plurality of insulation layers covering the recognition marks are exposed at least at a regions lying over the recognition marks.

6. The method for adjusting a characteristics of a multi-layer electronic component as claimed in claim 5, wherein said trimming is performed by applying a laser beam from a side of the insulation layers covering the recognition marks with respect to the predetermined insulation layer.

7. The method for adjusting a characteristics of a multi-layer electronic component as claimed in claim 1, wherein said recognition marks are arranged in the cutting allowance regions for enabling extraction of the plurality of multi-layer electronic components by cutting.

8. The method for adjusting a characteristics of a multi-layer electronic component as claimed in claim 2, wherein said recognition marks are arranged in the cutting allowance regions for enabling extraction of the plurality of multi-layer electronic components by cutting.

9. The method for adjusting a characteristics of a multi-layer electronic component as claimed in claim 3, wherein said recognition marks are arranged in the cutting allowance regions for enabling extraction of the plurality of multi-layer electronic components by cutting.

10. The method for adjusting a characteristics of a multi-layer electronic component as claimed in claim 4, wherein said recognition marks are arranged in the cutting allowance regions for enabling extraction of the plurality of multi-layer electronic components by cutting.

11. The method for adjusting a characteristics of a multi-layer electronic component as claimed in claim 5, wherein said recognition marks are arranged in the cutting allowance regions for enabling extraction of the plurality of multi-layer electronic components by cutting.

12. The method for adjusting a characteristics of a multi-layer electronic component as claimed in claim 6, wherein said recognition marks are arranged in the cutting allowance regions for enabling extraction of the plurality of multi-layer electronic components by cutting.

13. The method for adjusting a characteristics of a multi-layer electronic component as claimed in claim 1, wherein said trimming process for a multi-layer electronic component which the determination process is already performed and said the determination process for another multi-layer electronic component are performed in parallel.

14. The method for adjusting a characteristics of a multi-layer electronic component as claimed in claim 1, wherein said determination process is performed sequentially for a plurality of multi-layer electronic component and, thereafter said trimming process is performed sequentially for said plurality of multi-layer electronic component.

15. The method for adjusting a characteristics of a multi-layer electronic component as claimed in claim 1, wherein said multi-layer electronic component is voltage-controlled oscillators.

16. The method for adjusting a characteristics of a multi-layer electronic component as claimed in claim 1, wherein said trimming patterns are patterns which enable varying at least one of an inductance and a capacitance of themselves by trimming.

17. A characteristics adjusting apparatus for a multi-layer electronic component, comprising:
a determining unit for determining a characteristics of the multi-layer electronic component;
a calculating unit for calculating a required amount of trimming on a basis of a result of determination obtained by the determining unit; and
a trimming unit for applying trimming to a trimming pattern provided in the multi-layer electronic component in accordance with the amount of trimming obtained by the calculating unit.

18. The characteristics adjusting apparatus for a multi-layer electronic component as claimed in claim 17, wherein said calculating unit calculates the required amount of trimming by referring to a calculation table defining a relationship between a amount of trimming and a difference between desired characteristics and a characteristics of the multi-layer electronic component.

19. The characteristics adjusting apparatus for a multi-layer electronic component as claimed in claim 17, wherein said determining unit and the trimming unit are configured such that a determination by the determining unit and a trimming by the trimming unit are performed in parallel for different multi-layer electronic components.

20. The characteristics adjusting apparatus for a multi-layer electronic component as claimed in claim 18, wherein said determining unit and the trimming unit are configured such that a determination by the determining unit and a trimming by the trimming unit are performed in parallel for different multi-layer electronic components.
